(19) United States
(12) Patent Application Publication
(10) Pub. No.: US 2026/0199061 A1
(43) Pub. Date: Jul. 16, 2026

(54) PREHEATING AND THERMOFORMING POLYSULFONE FILM INTO DENTAL ALIGNERS

(71) Applicant: BIXBY INTERNATIONAL CORPORATION, Newburyport, MA (US)

(72) Inventor: Tim GLOWIK, Danvers, MA (US)

(73) Assignee: BIXBY INTERNATIONAL CORPORATION, Newburyport, MA (US)

(21) Appl. No.: 18/713,597

(22) PCT Filed: Jun. 29, 2023
(86) PCT No.: PCT/US2023/069433

§ 371 Date: May 24, 2024

Related U.S. Application Data
(60) Provisional application No. 63/373,434, filed on Aug. 24, 2022.

(51) Int. Cl. A61C 7/08; B29C 51/02; B29C 51/18; B29C 51/26; B29C 51/42; B29K 81/00; C08G 75/23; C08J 5/18

(52) U.S. Cl. CPC A61C 7/08; B29C 51/02; B29C 51/18; B29C 51/264; B29C 51/426; C08G 75/23; C08J 5/18; B29C 2793/0081; B29K 2081/06; C08J 2381/06

(57) ABSTRACT

A method includes preheating a stock film of polysulfone(PSU), (PPSF or PPSU) or polyether sulfone (PES) in an oven at a temperature of 350° F. to 450° F. for 30 to 200 seconds to generate a moisture-free film, the stock film in a form of a roll, a sheet, or a disc, cutting the moisture-free film into pieces, and subjecting each of the moisture-free pieces to a thermoforming process to produce a dental aligner.

### CROSS REFERENCE TO RELATED APPLICATIONS

This application is a National Phase filing under 35 U.S.C § 371 of International Application No. PCT/US2023/069433 filed Jun. 29, 2023, which claims the benefit from U.S. Provisional Patent Application No. 63/373,434 filed Aug. 24, 2022, which is incorporated by reference in its entirety.

### BACKGROUND OF THE INVENTION

The present invention generally relates to dental aligners, and in particular, to preheating and thermoforming polysulfone film into dental aligners.

Like traditional braces, dental aligners are designed to move teeth a little at a time. The aligners are plastic replicas of one's teeth. Wearing them puts gentle pressure on the teeth, ever-so-slightly repositioning them. Dental aligners can be clear or not clear. Clear aligners are one of many technological advancements that have made orthodontic treatment less conspicuous, and one of many appliances orthodontists use to move teeth and align jaws.

Dental aligners, as they are shaped using sheets of films, have a tendency to absorb water from the air and change their form. This changed form affects the functionality of these dental aligners. There is thus a need for a process which helps minimize the moisture accumulation in these dental aligners as they are formed.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features a method including preheating a stock polysulfone (PSU) film in an oven at a temperature of 350° F. to 450° F. for 30 to 200 seconds to generate a moisture-free PSU film, the stock PSU film in a form of a roll, a sheet, or a disc, cutting the moisture-free PSU film into pieces, and subjecting each of the moisture-free PSU pieces to a thermoforming process to produce a dental aligner.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other aspects will now be described in detail with reference to the accompanying drawings, wherein:

FIG. 1 illustrates an exemplary dental aligner made using a non-preheated PSU film.

FIG. 2 illustrates an exemplary dental aligner made using a preheated PSU film.

FIG. 3 illustrates an exemplary process 300 including preheating (310) a stock polysulfone (PSU) film in an oven at a temperature 350° F. to 450° F. for 30 to 200 seconds to generate a moisture-free PSU film, the stock PSU film in a form of a roll, a sheet, or a disc.

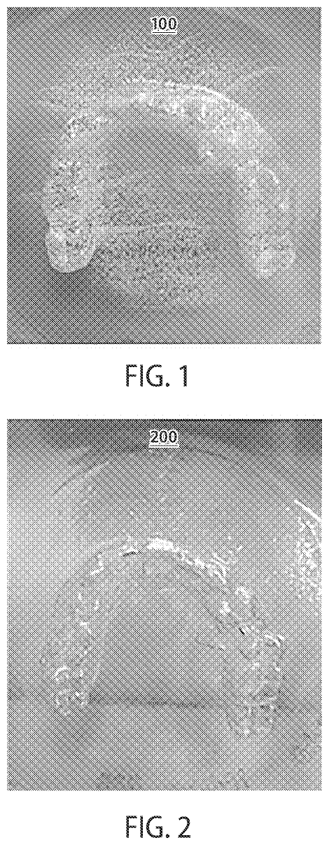

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used herein, the term “dental aligner” refers to a plastic orthodontic appliance that is shaped to fit over one's teeth and is used to correct or adjust the alignment of one's teeth. Dental aligners can be made of a variety of plastic material and the material can be opaque, transparent, semi-transparent, non-transparent, or a combination thereof.

As used herein, polysulfone(PSU) refers to any of a class of resinous organic chemical compounds belonging to the family of polymers in which the main structural chain most commonly includes benzene rings linked together by sulfonyl (—SO₂—), ether (—O—), and isopropylidene (—C(CH₃)₂—) groups.

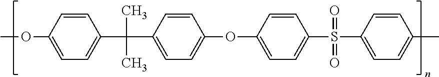

PSU is a high temperature, amber colored, semi-transparent plastic material with good mechanical properties. Polysulfone is resistant to degradation from hot water and steam and it is often used in medical and food preparation applications where repeated sterilization is required.

The present invention provides a process for extracting moisture from a polysulfone (PSU) film to render an essentially moisture-free PSU film, the process including preheating the PSU film in an oven at a temperature of from about 350° F. to about 450° F. for at least thirty seconds but not more than two hundred seconds.

A preferred embodiment provides a process wherein the PSU film is in the form of a roll, sheet, or a disc, each respectively having a width of from about four inches to about six inches and a length of from about ten feet to about five hundred feet, and has a thickness of from about 15 mil to about 40 mil.

Another preferred embodiment provides a process wherein the PSU film is in the form of a roll having a width of from about 5 inches and a length of from about 25 feet to about 100 feet. A further preferred embodiment provides a process wherein the PSU film is in the form of a roll having a width of from about 5 inches and a length of from about 25 feet to about 60 feet.

Another preferred embodiment provides a process including preheating the PSU film in an oven at a temperature of from about 400° F. to about 420° F. for at least 75 seconds but not more than 125 seconds. A further preferred aspect of this embodiment provides a process wherein the process includes preheating the PSU film in an oven at a temperature of 410° F. for 90 seconds.

Yet another embodiment provides a process wherein the PSU film is in the form of a roll, and further wherein the preheating oven includes an accumulator section to maintain the PSU film in a dry condition. Yet another preferred embodiment provides a process wherein the moisture free PSU film is cut into circular pieces from about 4 to about 6 inches in diameter. A further preferred embodiment provides a process wherein the moisture free PSU film is cut into circular pieces having a 5 inch diameter.

Another aspect of the invention provides a process wherein the moisture free PSU film pieces are subjected to a thermoforming process using a device capable of stamping the circular pieces into a dental aligner. A further preferred embodiment provides a process wherein the circular PSU film pieces have a thickness of from about 15 mil to about 40 mil. A further preferred embodiment provides a process wherein the circular PSU film pieces have a thickness of about 20 mil.

The present invention utilizes an oven including a chamber with a belt like mechanism that is capable of moving the PSU film through the oven as the PSU film is being heated to temperatures of up to 500° F. These ovens can be custom manufactured to meet the specific requirements of a user.

The present invention also utilizes a thermoforming process that transforms a disc into a dental aligner, such as, for an example, a BIOSTAR®, which is a pressure moulding machine with many applications in dental pressure moulding and orthodontics

Films in the form of a roll can also be transformed into dental aligners using similar techniques.

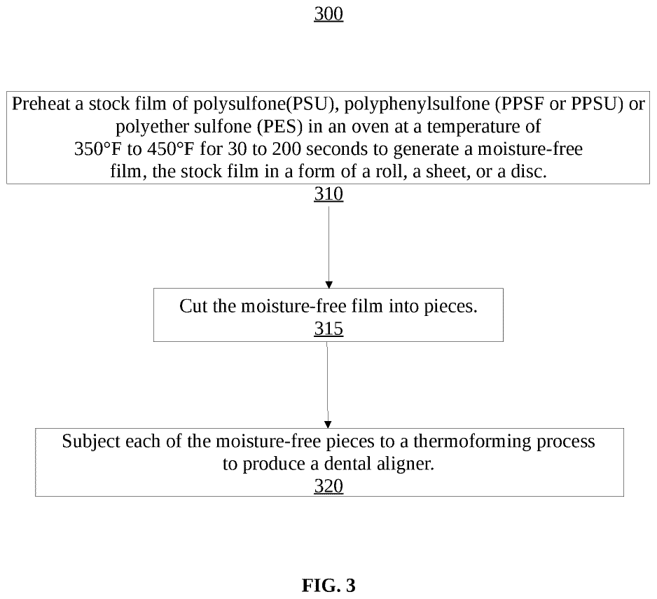

As shown in FIG. 3, a process 300 includes preheating (310) a stock polysulfone (PSU) film in an oven at a temperature 350° F. to 450° F. for 30 to 200 seconds to generate a moisture-free PSU film, the stock PSU film in a form of a roll, a sheet, or a disc.

Process 300 cuts (315) the moisture-free PSU film into pieces.

Process 300 subjects (320) each of the moisture-free PSU pieces to a thermoforming process to produce a dental aligner.

Although only a few embodiments have been disclosed in detail above, other modifications are possible. All such modifications are intended to be encompassed within the following claims.

1. A method comprising the steps of:
(1) preheating a stock film of polysulfone PSU), polyphenylsulfone (PPSF or PPSU) or polyether sulfone (PES) in an oven at a temperature of 350° F. to 450° F. for 30 to 200 seconds to generate a moisture-free film, the stock film in a form of a roll, a sheet, or a disc;
(2) subjecting the moisture-free film to a thermoforming process in a dental pressure molding machine to produce a clear, transparent dental aligner;
whereby the execution of step (1) before step (2) produces a clear, transparent, and aesthetic dental aligner but the execution of step (2) without an execution of step (1) produces a white colored, bubbled, opaque, and noticeable dental aligner.

2. The method of claim 1 wherein the dental aligner is an orthodontic appliance shaped to fit over teeth to correct or adjust an alignment of teeth.

3. The method of claim 1 wherein the stock film is one of a class of resinous organic chemical compounds belonging to a family of polymers in which the main structural chain most commonly includes benzene rings linked together by sulfonyl (—SO₂—), ether (—O—), and isopropylidene (—C(CH₃)₂—) groups.

4. The method of claim 1 wherein the roll, sheet and disc each respectively have a width of from 4 inches to 6 inches and a length of 10 feet to 500 feet, and has a thickness of 15 mil to 40 mil.

5. The method of claim 1 wherein the stock film is in a form of a roll having a width of 5 inches and a length of 25 feet to 100 feet.

6. The method of claim 1 wherein the stock film is in a form of a roll having a width of 5 inches and a length of 25 feet to 60 feet.

7. The method of claim 1 wherein the preheating occurs in the oven at a temperature of 400° F. to 420° F. for 75 to 125 seconds.

8. The method of claim 1 wherein the preheating occurs in the oven at a temperature of 410° F. for 90 seconds.

9. The method of claim 1 wherein the oven includes an accumulator section to maintain the film in a dry condition.

10. The method of claim 1 wherein the oven includes a chamber with a belt mechanism designed to move the stock film through the oven as the film is being heated to temperatures of up to 500° F.

11. A method comprising:
preheating a stock polyphenylsulfone (PPSU) film in an oven at a temperature of 350° F. to 450° F. for 30 to 200 seconds to generate a moisture-free PPSU film, the stock PPSU film in a form of a roll, a sheet, or a disc;
cutting the moisture-free PPSU film into pieces; and
subjecting each of the moisture-free pieces to a thermoforming process to produce a dental aligner.

12. The method of claim 11 wherein the preheating occurs in the oven at a temperature of 400° F. to 420° F. for 75 to 125 seconds.

13. The method of claim 11 wherein the preheating occurs in the oven at a temperature of 410° F. for 90 seconds.

14. The method of claim 11 wherein the oven includes an accumulator section to maintain the film in a dry condition.

15. The method of claim 11 wherein the oven includes a chamber with a belt mechanism designed to move the stock film through the oven as the film is being heated to temperatures of up to 500° F.

16. A method comprising:
preheating a stock polyether sulfone (PES) film in an oven at a temperature of 350° F. to 450° F. for 30 to 200 seconds to generate a moisture-free PES film, the stock PES film in a form of a roll, a sheet, or a disc;
cutting the moisture-free PES film into pieces; and
subjecting each of the moisture-free pieces to a thermoforming process to produce a dental aligner.

17. The method of claim 16 wherein the preheating occurs in the oven at a temperature of 400° F. to 420° F. for 75 to 125 seconds.

18. The method of claim 16 wherein the preheating occurs in the oven at a temperature of 410° F. for 90 seconds.

19. The method of claim 16 wherein the oven includes an accumulator section to maintain the film in a dry condition.

20. The method of claim 16 wherein the oven includes a chamber with a belt mechanism designed to move the stock film through the oven as the film is being heated to temperatures of up to 500° F.
